(19) United States
(12) Patent Application Publication
(10) Pub. No.: US 2023/0075001 A1
(43) Pub. Date: Mar. 9, 2023

(54) Folding Base for Supporting an Object

(71) Applicant: Volonic, Inc., Newport Beach, CA (US)

(72) Inventors: Henrik Jacobsen, Copenhagen (DK); David Danielson, Irvine, CA (US); Shawn Dougherty, Newport Beach, CA (US)

(73) Assignee: Volonic, Inc., Newport Beach, CA (US)

(21) Appl. No.: 17/467,210

(22) Filed: Sep. 4, 2021

(51) Int. Cl. F16M 11/20; H02J 7/02; H02J 7/00; H02J 50/10; F16M 11/22

(52) U.S. Cl. CPC F16M 11/2021; H02J 7/02; H02J 7/0044; H02J 50/10; F16M 11/22

(57) ABSTRACT

A folding base is provided for supporting and optionally charging an object positioned thereon. The folding base transitions from a folded configuration, where a flap hinged to a main body is folded flat against the main body, so that an object support surface of the main body is in a substantially horizontal orientation, to a deployed configuration, where the flap remains horizontal and supports the main body in a tilted orientation. The object can be supported in both configurations due to the retractable object support that is retractable when in the folded configuration so that the object can lay flat on the object support surface without interference from the retractable object support and automatically extendable in the deployed configuration so that the object can lean on the object support surface with object resting on the retractable object support.

### BACKGROUND

The subject of this patent application relates generally to stands, pads, and other bases for supporting and/or charging electronic devices or other objects set thereupon.

By way of background, existing stands, bases, and/or pads for supporting objects, such as electronic devices, can be folded to transition the bed region (region upon which the object rests) from a horizontal orientation to an inclined orientation. Once inclined, the device can slide off the bed region, unless there is a shelf or other support to prevent this. However, it is undesirable to have a protruding shelf when in the horizontal orientation, which may hinder the user from easily sliding the device off the bed region without lifting the device initially. What is needed, is a support that enables the transition between the inclined orientation and the horizontal orientation without substantial protrusion of a shelf or other support when in the horizontal orientation.

Aspects of the present invention fulfill these needs and provide further related advantages as described in the following summary.

### SUMMARY

Aspects of the present invention teach certain benefits in construction and use which give rise to the exemplary advantages described below.

The present specification discloses a folding base including a first body having an object support surface opposite a back surface, a second body pivoted to the first body to permit rotation between a folded configuration with the second body folded adjacent to the back surface of the first body and a deployed configuration with the second body extending from the first body, a retractable object support that is extendable from the object support surface of the first body and moveable between a retracted position and an extended position, an outwardly biasing mechanism producing an extending force and configured to push the retractable object support to the extended position when in the deployed configuration. In some embodiments, a folding base disclosed herein optionally comprises an inwardly biasing mechanism producing a retracting force and configured to hold the retractable object support in the retracted position when in the folded configuration, where the retracting force is greater than the extending force when in the folded configuration and the retractable object support is in the retracted position, and the retracting force is less than the extending force when in the deployed configuration.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings, which are incorporated in and constitute a part of this specification, illustrate aspects of the disclosed subject matter in at least one of its exemplary embodiments, which are further defined in detail in the following description. Features, elements, and aspects of the disclosure are referenced by numerals with like numerals in different drawings representing the same, equivalent, or similar features, elements, or aspects, in accordance with one or more embodiments. The drawings are not necessarily to scale, emphasis instead being placed upon illustrating the principles herein described and provided by exemplary embodiments of the invention. In such drawings:

FIG. 1 is an assembled top perspective view of an exemplary embodiment of a folding base disclosed herein, illustrated in a folded configuration;

FIG. 2 is an assembled top perspective view of the folding base of FIG. 1, illustrated in a deployed configuration;

FIG. 3 is an exploded bottom perspective view of the folding base of FIG. 1;

FIG. 4 is an exploded top perspective view of the folding base of FIG. 1;

FIG. 5 is a top view of the folding base of FIG. 1;

FIG. 6 is a magnified cross-sectional view of the anchored hole cover of FIG. 1, taken at 6-6, illustrating the internal components in the folded configuration;

FIG. 7 is a magnified partial cross-sectional view of the anchored hole cover of FIG. 1, taken at 7-7, illustrating an inwardly biasing portion of a retractable support in the folded configuration;

FIG. 8 is a magnified cross-sectional view of the anchored hole cover of FIG. 1, taken at 8-8, illustrating the inwardly biasing portion of the retractable support in the deployed configuration;

FIG. 9 is a magnified partial cross-sectional view of the anchored hole cover of FIG. 1, taken at 9-9, illustrating an outward biasing portion of the retractable support in the folded configuration; and

FIG. 10 is a magnified cross-sectional view of the anchored hole cover of FIG. 1, taken at 10-10, illustrating the outwardly biasing portion of the retractable support in the deployed configuration.

### DETAILED DESCRIPTION

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

The present specification discloses a folding base for supporting and optionally charging an object (such as electronic device, art object, etc.) positioned thereon. The folding base transitions from a folded configuration, where a flap hinged to a main body is folded flat against the main body, so that an object support surface of the main body is in a substantially horizontal orientation, to a deployed configuration, where the flap remains horizontal or protrudes from the main body and supports the main body in a tilted or upright orientation. The object can be supported in both configurations due to the retractable object support that is retracted when in the folded configuration so that the object can lay flat on the object support surface and automatically extended in the deployed configuration so that the object can lean on the object support surface with object resting on the retractable object support. Advantageously, when the retractable object support is retracted in the folded configuration, it does not unduly interfere with the object being positioned or removed from the object support surface, yet it supports the object and prevents it from sliding off the object support surface when in the deployed configuration.

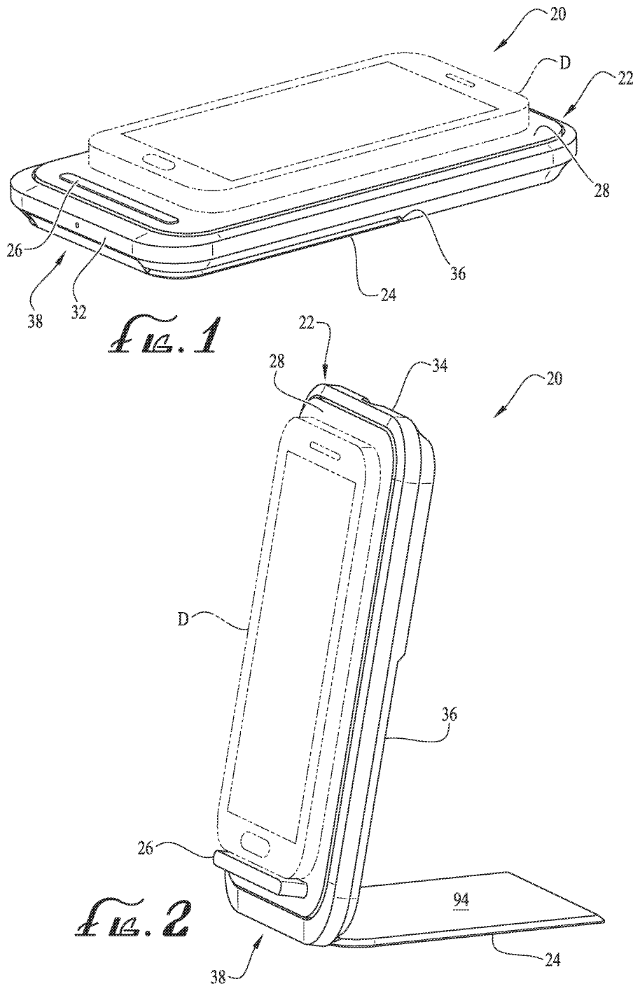

Referring first to FIGS. 1 & 2, an example embodiment of the present folding base 20 is illustrated in the folded configuration (FIG. 1) and in the deployed configuration (FIG. 2). The folding base 20 generally includes a main body 22 (which is also referred to herein as a charging pad and a first body) with a flap 24 (which is also referred to herein as a second body or a horizontal body) hinged to or otherwise configured to pivot relative to main body 22. In the folded configuration, flap 24 is folded against (e.g., substantially parallel and adjacent with little to no gap or simply permitting the horizontal positioning of main body 22) back surface 30, within a recessed portion 36, so that object support surface 28 (which is also referred to herein as a device support surface or a front surface) is positioned in a horizontal orientation (e.g., with little or no tilt, such that object or device D will remain on object support surface 28 without sliding or rolling off). In the deployed configuration, flap 24 is tilted away from back surface 30 of main body 22 about a hinge assembly 38, such that flap 24 is horizontal and resting upon a support surface (e.g., a tabletop or the like) and main body 22 with object support surface 28 is in the tilted orientation relative to flap 24.

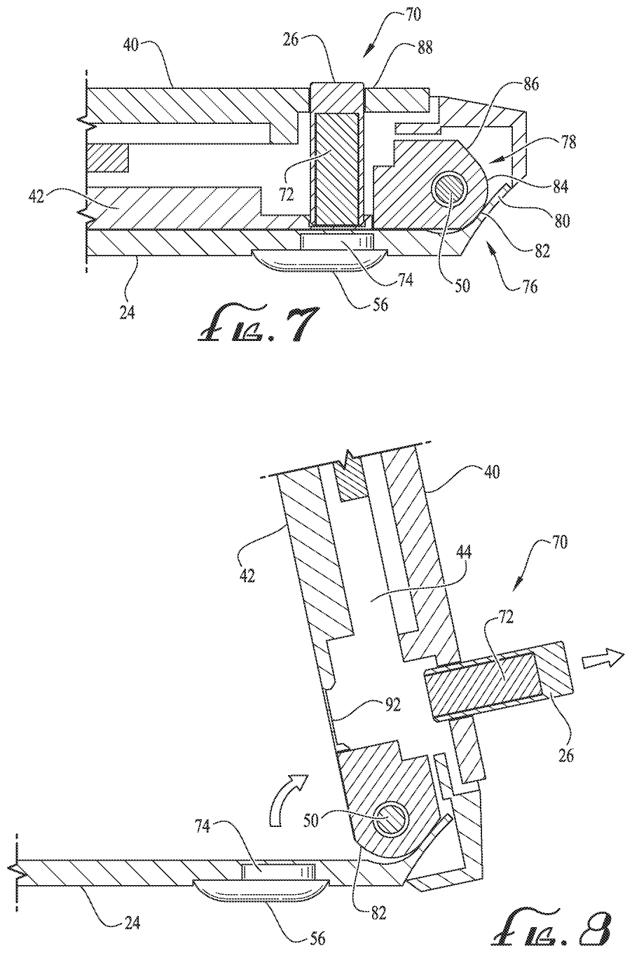

Flap 24 is selectively locked in either the folded configuration or the deployed configuration by a hinge catch assembly 76 (as further described below in the discussion of FIGS. 7-10), so that flap 24 rigidly holds and supports main body 22 in the tilted orientation. In the folded configuration, retractable object support 26 is in the retracted position, such that it is just above, flush with, or below object support surface 28, such that retractable object support 26 minimally interferes or does not substantially interfere with the placement or removal of device D (or other type of object) positioned thereon. In the deployed configuration, retractable object support 26 is in the extended position, such that it is capable of at least partially supporting device D to prevent it from unintentionally sliding off object support surface 28.

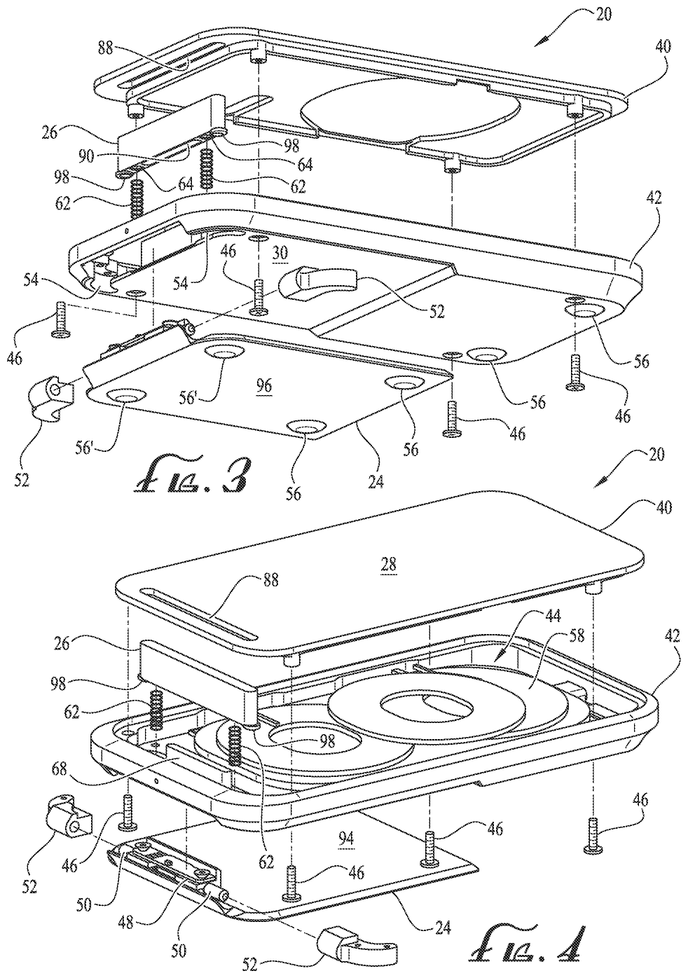

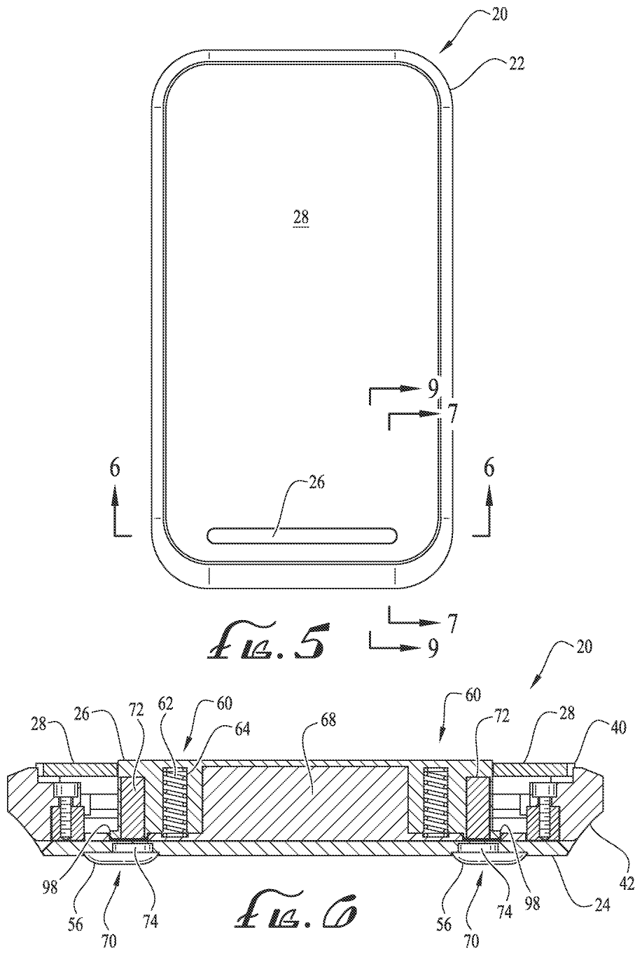

As shown in FIGS. 3, 4 & 6, main body 22 comprises an enclosure with a top housing 40 attached to a bottom housing 42 by screws 46 about the perimeter to delineate an interior space 44 for housing various components, if required. In one or more embodiments, main body 22 may be simply hollow or solid, if no charging components are required. In some embodiments, folding base 20 optionally includes an inductive charger circuitry 58 known in the industry positioned within interior space 44, with coils configured to be in electrical communication with compatible circuitry in device D to permit the wireless transmission of power. Not shown, are further circuitry related to operation and supplying of power to inductive charger circuitry 58. Of course, if the present folding base 20 is only intended as a stand for device D or other type of object, then the internal circuitry would not be required.

In one or more embodiments, retractable object support 26 is an elongated, shelf-like structure, which integrates with at least a portion of both the outwardly biasing mechanism and an inwardly biasing mechanism, when present. Retractable object support 26 includes an elongated guide slot 90, two spring bores 64, two first magnetic components 72, and a limiter protrusion 98 on each end. A retractable support guide 68 is a wall-like or shelf-like protrusion that extends upward from bottom housing 42 toward top housing 40 within interior space 44, and is shaped to slide within elongated guide slot 90 to permit smooth extension and retraction of retractable object support 26 thereon. Although retractable support guide 68 is illustrated as a wall-like structure, other structures that provide guidance to the movement of retractable object support 26 are possible, such as protruding rods or the like. An elongated slot 88 is formed through object support surface 28 of top housing 40. Elongated slot 88 is configured to receive therethrough retractable object support 26 and to provide clearance to permit extension and retraction of retractable object support 26.

Still referring to FIGS. 3, 4 & 6, each spring bore 64 receives a compression coil spring 62, where each spring 62 is compressible within their respective spring bores 64 against respective spring seats 66 formed in interior space 44 of bottom housing 42 to bias the retractable object support 26 away from bottom housing 42 toward a protruded position extending through elongated slot 88 and above object support surface 28. Limiter protrusions 98 formed on each end of retractable object support 26 catches on an inside edge (i.e., an edge within interior space 44) of elongated slot 88 to prevent extraction of retractable object support 26 through elongated slot 88, thus limiting the travel of retractable object support 26 on retractable support guide 68 and defining the maximum protrusion height above object support surface 28. Although outwardly biasing mechanism 60 utilizes coil springs 62 to provide an outward biasing force, other appropriate springs can be used (both integrally molded springs or separate component springs), magnets can be used, or other force producing designs can be used.

Referring to FIG. 6, two first magnetic components 72 are inset and secured within respective bores of retractable object support 26 (adjacent and parallelly arranged to spring bores 64) and directed toward a magnet seat 92 within bottom housing 42. First magnetic components 72 move up and down with retractable object support 26 and are configured to produce an inward biasing force in the folded configuration, where first magnetic components 72 are brought into close proximity to second magnetic components 74 coupled to flap 24. Inwardly biasing mechanism 70 comprises first magnetic components 72 and second magnetic components 74. First and second magnetic components 72, 74 can be any number of materials that produce a magnetic field or are attracted/repulsed by magnetic fields, such as ferromagnetic materials, permanent magnets, rare earth magnets, and so on. For example, first magnetic components 72 can be a neodymium magnet; and second magnetic components 74 can be small piece of steel attracted to the neodymium magnet. Although inwardly biasing mechanism 70 utilizes first and second magnetic components 72, 74 to provide a biasing force, springs (both integrally molded springs or separate component springs) or other force producing designs can be used.

As shown in FIGS. 3 & 4, flap 24, it is a plate-like structure that includes a top surface 94 opposite a bottom surface 96. As shown in FIGS. 3 & 6, bottom surface 96 includes foot pads 56 level with foot pads 56 on the bottom housing 42, and are configured to provide stable positioning of folding base 20 on a support surface. As best seen in FIG. 6, Second magnetic components 74 are positioned beneath each of the two foot pads 56′ closest to the bottom edge 32 of the main body 22, which are aligned with the respective first magnetic components 72 when in the folded configuration, so that the first magnetic components 72 are positioned directly above their respective second magnetic components 74. Thus, in the folded configuration, the springs 62 will produce a force that pushes the retractable object support 26 toward the protruded position. Simultaneously, and still in the folded configuration, the first magnetic components 72 and the second magnetic components 74 are attracted to produce the inward biasing force that pulls the retractable support guide 68 toward the retracted position. In one or more example embodiments, in the folded configuration, the inward biasing force produced by the magnetic components 72, 74 is greater than the outward biasing force produced by the springs 62, so that the resultant biasing force will produce a net inward biasing force that pulls and/or maintains the retractable object support 26 in the retracted position.

Retractable object support 26 may need be manually pushed inward to the retracted position to position first and second magnetic components 72, 74 in sufficiently close proximity to overcome the spring force. Alternatively, first and second magnetic components 72, 74 can be designed to produce sufficient magnetic force, such that retractable object support 26 is automatically drawn in to the retracted position due to the magnetic force overcoming the spring force even over the gap between first and second magnetic components 72, 74 when at the initial protruded position.

Referring now to FIG. 4, hinge assembly 38, in this example embodiment, comprises a hinge base 48 mounted on top surface of the flap 24 and with two hinge pins 50 protruding therefrom, which are configured to receive respective hinge leaves 52 rotatably mounted to hinge pins 50. Hinge leaves 52 are mounted to bottom housing 42 within respective hinge mortises 54 formed into back surface 30, rotatably coupling flap 24 to bottom housing 42, to permit the rotation of main body 22 relative to flap 24 about hinge assembly 38. Of course, hinge assembly 38 can be positioned midway (or some other position) on back surface 30 of main body 22, rotating out and acting much like a kickstand to hold main body 22 in the tilted configuration, without changing the basic operation of present folding base 20.

FIGS. 7 & 8 illustrate inwardly biasing mechanism 70 as folding base 20 transitions from folded configuration of FIG. 7 to deployed configuration of FIG. 8. It can be seen that retractable object support 26 is initially in the retracted position where first magnetic component 72 is aligned with and placed in immediate or close proximity of second magnetic components 74 (with a thin layer of material therebetween, from flap 24 material and bottom housing 42), which keeps retractable object support 26 in the retracted position. Main body 22 is then rotated about hinge assembly 38 which moves first magnetic components 72 away from second magnetic components 74 a sufficient distance that the inward biasing force of the magnets is sufficiently weakened to less than the outwardly biasing force of springs 62. Thus, during transition to the deployed configuration, retractable object support 26 is forced outwardly into the protruded position by springs 62.

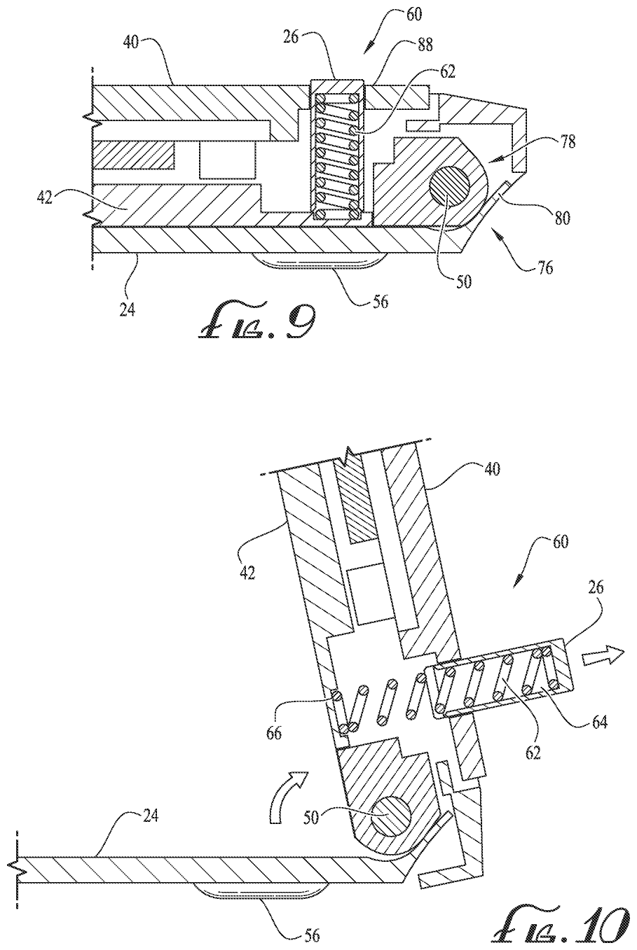

FIGS. 8 and 9 illustrate outwardly biasing mechanism 60 with the simultaneous (i.e., acting at the same time as the illustrate inwardly biasing mechanism 70) action of springs 62 in the transition between the folded configuration of FIGS. 7 & 9 to the deployed configuration of FIGS. 8 & 10. As described above (in reference to FIG. 7), retractable object support 26 is retracted against the force of spring 62, which is compressed due to the magnetic force. Transitioning to the deployed configuration, the spring force overcomes the magnetic force, permitting springs 62 to expand to push retractable object support 26 to the protruding position seen in FIG. 10.

The action of hinge catch assembly 76 in the transition between the folded configuration to the deployed configuration can also be seen in FIGS. 7-10. Hinge leaf 52 includes a surface with a cam lobe 78 having a first surface portion 82, leading to the second surface portion 84, and leading therefrom to a third surface portion 86. A cantilevered spring member 80 extends from flap 24, where cantilevered spring member 80 is brought into contact with and rides on cam lobe 78 as cam lobe 78 rotates with the movement of main body 22, with cantilevered spring member 80 flexing about its root to maintain contact with cam lobe 78 surface. In the folded configuration, cantilevered spring member 80 contacts cam lobe 78 at first surface portion 82, where the spring force of cantilevered spring member 80 pushing against first surface portion 82 creates a catch effect that temporarily resists rotation to keep flap 24 against back surface 30 of main body 22, until sufficient manual force is applied. As cam lobe 78 continues to rotate, cantilevered spring member 80 contacts cam lobe 78 at second surface portion 84, which is curved to create an unstable hinge rotational position, where force cantilevered spring member 80 on cam lobe 78 will bias cam lobe 78 to rotate one direction or the other (e.g., like the nose of a cam which is a region of comparatively small radius). Thus, in this position, (if released from the user's grip) folding base 20 will tend to snap back to the folded configuration or snap to the deployed (fully open) configuration. In the deployed configuration, cantilevered spring member 80 contacts cam lobe 78 at third surface portion 86, where the spring force of cantilevered spring member 80 pushing against third surface portion 86 creates yet another catch effect that temporarily resists rotation to keep flap 24 extended away from back surface 30 of main body 22, until sufficient manual force is applied to overcome hinge catch assembly 76. First surface portion 82 and third surface portion 86 generally will have a larger radius than second surface portion 84 to discourage movement from those regions without manual input of force.

Present folding base 20 provides a versatile support that transitions from a horizontal support pad to a tilted or vertical stand. And with that transition, folding base 20 automatically, mechanically transforms the means of supporting the object placed thereon from a horizontal pad to a tilted or vertical shelf. In the embodiment with wireless charging capabilities, retractable device support 26 maintains the position of device D in alignment with inductive charger circuitry 58. While in the horizontal configuration, retractable device support 26 retracts to permit the user to place electronic device D in any desired position or orientation, while allowing charging.

Aspects of the present specification can also be described by the following embodiments:
1. A folding base for supporting an object comprising a main body having a front surface opposite a back surface, with the front surface of the main body configured to at least partially support the object thereon; a horizontal body pivoted to the main body and being configured to fold adjacent to the back surface of the main body in a folded configuration and is configured to pivot away from the back surface of the main body in a deployed configuration, in the folded configuration the front surface is in a substantially horizontal orientation and in the deployed configuration the front surface is in a tilted orientation with the horizontal body remaining in substantially horizontal to provide stability; and a retractable object support coupled to the main body and extendable from the front surface, the retractable object support being operable in conjunction with an inwardly biasing assembly and an outwardly biasing assembly, the inwardly biasing assembly biasing the retractable object support in an at least partially retracted position relative to the front surface when in the folded configuration, the outwardly biasing assembly biasing the retractable object support in a protruded position relative to the front surface when in the deployed configuration, wherein the retractable object support is configured to be sufficiently protruding above the front surface of the main body in the protruded position to support the object.
2. The folding base of embodiment 1, wherein the retractable object support is a shelf.
3. The folding base of embodiments 1 or 2, wherein the horizontal body is a plate-like structure.
4. The folding base of any one of embodiments 1-3, wherein the outwardly biasing assembly comprises a spring biased to push the retractable object support to the protruded position.
5. The folding base of any one of embodiments 1-4, wherein the inwardly biasing assembly comprises a first magnetic component and a second magnetic component, wherein the first magnetic component and the second magnetic component are attracted to one another.
6. The folding base of any one of embodiments 1-5, wherein the first magnetic component and the second magnetic component are proximally arranged when in the folded configuration and distally arranged when in the deployed configuration.
7. The folding base of any one of embodiments 1-6, wherein the first magnetic component is coupled to the retractable object support and the second magnetic component is coupled to the horizontal body, wherein a magnetic force between the first magnetic component and the second magnetic component decreases when transitioning from the folded configuration to the deployed configuration.
8. The folding base of any one of embodiments 1-7, wherein, in the folded configuration with the retractable object support in the at least partially retracted position, an inward biasing force produced by the magnetic force is greater than an outward biasing force produced by the outwardly biasing assembly, and, in the deployed configuration, the inward biasing force is less than the outward biasing force to permit the outwardly biasing force to push the retractable object support to the protruded position.
9. The folding base of any one of embodiments 1-8, wherein the outwardly biasing assembly comprises a spring biasing the retractable object support toward the protruded position.
10. The folding base of any one of embodiments 1-9, wherein the object is an electronic device and the main body houses an induction charger configured to charge the electronic device when the electronic device is positioned on the front surface.
11. A folding base comprising a first body having an object support surface opposite a back surface; a second body pivoted to the first body to permit rotation between a folded configuration with the second body folded adjacent to the back surface of the first body and a deployed configuration with the second body extending from the first body; a retractable object support extendable from the object support surface of the first body and moveable between a retracted position and an extended position; an outwardly biasing mechanism producing an extending force and configured to push the retractable object support to the extended position when in the deployed configuration; and an inwardly biasing mechanism producing a retracting force and configured to hold the retractable object support in the retracted position when in the folded configuration; wherein the retracting force is greater than the extending force when in the folded configuration and the retractable object support is in the retracted position, and the retracting force is less than the extending force when in the deployed configuration.
12. The folding base of embodiment 11, wherein in the folded configuration the object support surface is in a substantially horizontal orientation and in the deployed configuration the object support surface is in a tilted orientation with the second body providing stability to maintain the tilted orientation.
13. The folding base of embodiments 11 or 12, wherein the inwardly biasing mechanism comprises a first magnetic component and a second magnetic component, wherein the first magnetic component and the second magnetic component are attracted to one another.
14. The folding base of any one of embodiments 11-13, wherein the first magnetic component is coupled to the retractable object support and the second magnetic component is coupled to the second body, wherein the retracting force is a magnetic force between the first magnetic component and the second magnetic component that decreases when transitioning from the folded configuration to the deployed configuration.
15. The folding base of any one of embodiments 11-14, wherein the outwardly biasing mechanism comprises a spring and the extending force is a spring force continuously applied to the retractable object support.
16. The folding base of any one of embodiments 11-15, wherein the first body houses an induction charger configured to charge an electronic device when the electronic device is positioned on the object support surface.
17. A folding base for charging an electronic device comprising a charging pad housing an inductive charger, the charging pad having an object support surface opposite a back surface; a flap hinged to the back surface of the charging pad and configured to selectively rotate between a folded configuration with the flap folded adjacent to the back surface of the of the charging pad and a deployed configuration with the second body extending from the charging pad, in the folded configuration the charging pad and flap are configured to rest on a support surface in a substantially horizontal orientation, in the deployed configuration the charging pad is in a tilted orientation with the horizontal body configured to contact the support surface to provide stability; a retractable device support extendable from the object support surface of the first body and moveable between a retracted position and an extended position; an inwardly biasing magnetic pair producing a retracting magnetic force on the retractable device support and being configured to hold the retractable device support in the retracted position when in the folded configuration, the inwardly biasing mechanism having a first magnetic component coupled to the retractable device support and a second magnetic component coupled to the flap, the retracting magnetic force between the first magnetic component and the second magnetic component decreases when transitioning from the folded configuration to the deployed configuration; and an outwardly biasing spring producing an extending spring force and configured to push the retractable device support to the extended position when in the deployed configuration.
18. The folding base of embodiment 17, wherein the retracting magnetic force applied to the retractable device support is greater than the extending spring force simultaneously applied to the retractable device support when in the folded configuration and the retractable object support is in the retracted position, and the retracting magnetic force is less than the extending spring force when in the deployed configuration.
19. The folding base of embodiments 17 or 18, wherein the retractable device support at least partially supports the electronic device on the object support surface of the charging pad to hold the electronic device in communication with the inductive charger when in the deployed configuration with the charging pad in the tilted orientation.
20. The folding base of any one of embodiments 17-19, wherein the retractable device support is a shelf.

In closing, foregoing descriptions of embodiments of the present invention have been presented for the purposes of illustration and description. It is to be understood that, although aspects of the present invention are highlighted by referring to specific embodiments, one skilled in the art will readily appreciate that these described embodiments are only illustrative of the principles comprising the present invention. As such, the specific embodiments are not intended to be exhaustive or to limit the invention to the precise forms disclosed. Therefore, it should be understood that embodiments of the disclosed subject matter are in no way limited to a particular element, compound, composition, component, article, apparatus, methodology, use, protocol, step, and/or limitation described herein, unless expressly stated as such.

In addition, groupings of alternative embodiments, elements, steps and/or limitations of the present invention are not to be construed as limitations. Each such grouping may be referred to and claimed individually or in any combination with other groupings disclosed herein. It is anticipated that one or more alternative embodiments, elements, steps and/or limitations of a grouping may be included in, or deleted from, the grouping for reasons of convenience and/or patentability. When any such inclusion or deletion occurs, the specification is deemed to contain the grouping as modified, thus fulfilling the written description of all Markush groups used in the appended claims.

Furthermore, those of ordinary skill in the art will recognize that certain changes, modifications, permutations, alterations, additions, subtractions and sub-combinations thereof can be made in accordance with the teachings herein without departing from the spirit of the present invention. Furthermore, it is intended that the following appended claims and claims hereafter introduced are interpreted to include all such changes, modifications, permutations, alterations, additions, subtractions and sub-combinations as are within their true spirit and scope. Accordingly, the scope of the present invention is not to be limited to that precisely as shown and described by this specification.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

The words, language, and terminology used in this specification is for the purpose of describing particular embodiments, elements, steps and/or limitations only and is not intended to limit the scope of the present invention, which is defined solely by the claims. In addition, such words, language, and terminology are to be understood not only in the sense of their commonly defined meanings, but to include by special definition in this specification structure, material or acts beyond the scope of the commonly defined meanings. Thus, if an element, step or limitation can be understood in the context of this specification as including more than one meaning, then its use in a claim must be understood as being generic to all possible meanings supported by the specification and by the word itself.

The definitions and meanings of the elements, steps or limitations recited in a claim set forth below are, therefore, defined in this specification to include not only the combination of elements, steps or limitations which are literally set forth, but all equivalent structure, material or acts for performing substantially the same function in substantially the same way to obtain substantially the same result. In this sense it is therefore contemplated that an equivalent substitution of two or more elements, steps and/or limitations may be made for any one of the elements, steps or limitations in a claim set forth below or that a single element, step or limitation may be substituted for two or more elements, steps and/or limitations in such a claim. Although elements, steps or limitations may be described above as acting in certain combinations and even initially claimed as such, it is to be expressly understood that one or more elements, steps and/or limitations from a claimed combination can in some cases be excised from the combination and that the claimed combination may be directed to a sub-combination or variation of a sub-combination. As such, notwithstanding the fact that the elements, steps and/or limitations of a claim are set forth below in a certain combination, it must be expressly understood that the invention includes other combinations of fewer, more or different elements, steps and/or limitations, which are disclosed in above combination even when not initially claimed in such combinations. Furthermore, insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. Accordingly, the claims are thus to be understood to include what is specifically illustrated and described above, what is conceptually equivalent, what can be obviously substituted and also what essentially incorporates the essential idea of the invention.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. For instance, as mass spectrometry instruments can vary slightly in determining the mass of a given analyte, the term “about” in the context of the mass of an ion or the mass/charge ratio of an ion refers to +/−0.50 atomic mass unit. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as, e.g., “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising”, variations thereof such as, e.g., “comprise” and “comprises”, and equivalent open-ended transitional phrases thereof like “including”, “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as, e.g., “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim, whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such, the embodiments described herein or so claimed with the phrase “comprising” expressly and unambiguously provide description, enablement, and support for the phrases “consisting essentially of” and “consisting of.”

Lastly, all patents, patent publications, and other references cited and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard is or should be construed as an admission that the inventors are not entitled to antedate such disclosure by virtue of prior invention or for any other reason. All statements as to the date or representation as to the contents of these documents are based on the information available to the applicant and do not constitute any admission as to the correctness of the dates or contents of these documents.

1. A folding base for supporting an object comprising:
a main body having a front surface opposite a back surface, the front surface of the main body configured to at least partially support the object thereon;
a horizontal body pivoted to the main body and is configured to fold adjacent to the back surface of the main body in a folded configuration and is configured to pivot away from the back surface of the main body in a deployed configuration, in the folded configuration the front surface is in a substantially horizontal orientation and in the deployed configuration the front surface is in a tilted orientation with the horizontal body remaining in substantially horizontal to provide stability; and
a retractable object support coupled to the main body and extendable from the front surface, the retractable object support being operable in conjunction with an inwardly biasing assembly and an outwardly biasing assembly, the inwardly biasing assembly biasing the retractable object support in an at least partially retracted position relative to the front surface when in the folded configuration, the outwardly biasing assembly biasing the retractable object support in a protruded position relative to the front surface when in the deployed configuration, wherein the retractable object support is configured to be sufficiently protruding above the front surface of the main body in the protruded position to support the object, and wherein the inwardly biasing assembly comprises a first magnetic component and a second magnetic component, wherein the first magnetic component and the second magnetic component are attracted to one another.

2. The folding base of claim 1, wherein the retractable object support is a shelf.

3. The folding base of claim 1, wherein the horizontal body is a plate like structure.

4. The folding base of claim 1, wherein the outwardly biasing assembly comprises a spring biased to push the retractable object support to the protruded position.

5. (canceled)

6. The folding base of claim 1, wherein the first magnetic component and the second magnetic component are proximally arranged when in the folded configuration and distally arranged when in the deployed configuration.

7. The folding base of claim 6, wherein the first magnetic component is coupled to the retractable object support and the second magnetic component is coupled to the horizontal body, wherein a magnetic force between the first magnetic component and the second magnetic component decreases when transitioning from the folded configuration to the deployed configuration.

8. The folding base of claim 7, wherein, in the folded configuration with the retractable object support in the at least partially retracted position, an inward biasing force produced by the magnetic force is greater than an outward biasing force produced by the outwardly biasing assembly, and, in the deployed configuration, the inward biasing force is less than the outward biasing force to permit the outwardly biasing force to push the retractable object support to the protruded position.

9. The folding base of claim 8, wherein the outwardly biasing assembly comprises a spring biasing the retractable object support toward the protruded position.

10. The folding base of claim 1, wherein the object is an electronic device and the main body houses an induction charger configured to charge the electronic device when the electronic device is positioned on the front surface.

11. A folding base comprising:
a first body having an object support surface opposite a back surface;
a second body pivoted to the first body to permit rotation between a folded configuration with the second body folded adjacent to the back surface of the first body and a deployed configuration with the second body extending from the first body;
a retractable object support extendable from the object support surface of the first body and moveable between a retracted position and an extended position;
an outwardly biasing mechanism producing an extending force and configured to push the retractable object support to the extended position when in the deployed configuration; and
an inwardly biasing mechanism producing a retracting force and configured to hold the retractable object support in the retracted position when in the folded configuration, the inwardly biasing mechanism comprising a first magnetic component and a second magnetic component, wherein the first magnetic component and the second magnetic component are attracted to one another;
wherein the retracting force is greater than the extending force when in the folded configuration and the retractable object support is in the retracted position, and the retracting force is less than the extending force when in the deployed configuration.

12. The folding base of claim 11, wherein in the folded configuration the object support surface is in a substantially horizontal orientation and in the deployed configuration the object support surface is in a tilted orientation with the second body providing stability to maintain the tilted orientation.

13. (canceled)

14. The folding base of claim 10, wherein the first magnetic component is coupled to the retractable object support and the second magnetic component is coupled to the second body, wherein the retracting force is a magnetic force between the first magnetic component and the second magnetic component that decreases when transitioning from the folded configuration to the deployed configuration.

15. The folding base of claim 10, wherein the outwardly biasing mechanism comprises a spring and the extending force is a spring force continuously applied to the retractable object support.

16. The folding base of claim 11, wherein the first body houses an induction charger configured to charge an electronic device when the electronic device is positioned on the object support surface.

17. A folding base for charging an electronic device comprising:
a charging pad housing an inductive charger, the charging pad having an object support surface opposite a back surface;
a flap hinged to the back surface of the charging pad and configured to selectively rotate between a folded configuration with the flap folded adjacent to a back surface of the of the charging pad and a deployed configuration with the flap extending from the charging pad, in the folded configuration the charging pad and the flap are configured to rest on a support surface in a substantially horizontal orientation, in the deployed configuration the charging pad is in a tilted orientation with the flap configured to contact the support surface to provide stability;
a retractable device support extendable from the object support surface of the charging pad and moveable between a retracted position and an extended position;
an inwardly biasing magnetic pair producing a retracting magnetic force on the retractable device support and being configured to hold the retractable device support in the retracted position when in the folded configuration, the inwardly biasing mechanism having a first magnetic component coupled to the retractable device support and a second magnetic component coupled to the flap, the retracting magnetic force between the first magnetic component and the second magnetic component decreases when transitioning from the folded configuration to the deployed configuration; and
an outwardly biasing spring producing an extending spring force and configured to push the retractable device support to the extended position when in the deployed configuration.

18. The folding base of claim 17, wherein the retracting magnetic force applied to the retractable device support is greater than the extending spring force simultaneously applied to the retractable device support when in the folded configuration and the retractable object support is in the retracted position, and the retracting magnetic force is less than the extending spring force when in the deployed configuration.

19. The folding base of claim 17, wherein the retractable device support at least partially supports the electronic device on the object support surface of the charging pad to hold the electronic device in communication with the inductive charger when in the deployed configuration with the charging pad in the tilted orientation.

20. The folding base of claim 17, wherein the retractable device support is a shelf.
